(19) United States
(12) Patent Application Publication
(10) Pub. No.: US 2004/0172622 A1
(43) Pub. Date: Sep. 2, 2004

(54) Systems, methods and computer program products for performing a task in a software application

(75) Inventor: William G. Francis, Sudbury, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Inc., Irving, TX

(21) Appl. No.: 10/376,784

(22) Filed: Feb. 28, 2003

(51) Int. Cl. G06F 9/44

(52) U.S. Cl. 717/121; 717/109; 717/113

(57) ABSTRACT

A method for performing a task in a software application begins by determining a state of at least one data item, such as by determining a state of at least one configuration setting. After determining the states of the data items, at least one data item is identified based upon the state of the data items. For example, data items having a non-configured state can be identified. Thereafter, at least one operational display of the software application is presented based upon the identified data items. For example, the operational displays presented can comprise electronic pages formatted for display by a connectivity application. Each operational display presented includes at least one field for receiving at least one identified data item. After presenting the operational displays of the software application, the identified data items are received into the fields of the respective operational displays.

### FIELD OF THE INVENTION

The present invention relates generally to systems, methods and computer program products for performing a task in a software application and, more particularly, relates to systems, methods and computer program products for performing a task in a software application utilizing operational displays of the software application.

### BACKGROUND OF THE INVENTION

In many software applications today, users are taken through installation and configuration procedures to initialize and configure the software so that a processor such as a personal computer, a network appliance, server computer or other high level processor can operate the software application. In this regard, during installation, many software applications require user-supplied data prior to the processor being able to run the software application for its intended purpose. In many instances, the software application includes a plurality of displays that are displayed during operation of the application and that include the user-supplied data. As will be appreciated, then, the required user-supplied data are often not all logically related to one another, and as such, are not all located on a single display during operation of the application. As such, methods have been developed to allow users to input user-supplied data into such software applications prior to operation of the application.

One conventional technique by which users can configure software applications utilizes an instruction document, in either hard copy or an electronic document, that includes the steps needed to configure the system. According to this technique, for example, users are instructed to go to specified installation displays, or sections within a single installation display, and enter the required data items in designated locations. Such a technique, however, requires the user to work with both the instructions and the graphical user interface (GUI) to configure the software application for operation. Often, users attempt to use the application without reading the installation instructions, however, thereby failing to properly configure the software application. And even if users do read the instructions, it is common for one or more required pieces of information to be overlooked, again resulting in a failure to properly configure the software application.

According to another conventional technique, a separate installation wizard, or script, guides the user through the initialization process. During this process, the required user-supplied data items are typically grouped into either a single display in one or more data fields, or a series of contiguous displays. After the user supplies the necessary data, the installation wizard populates the fields of the software application with the user-supplied data. Thereafter, the system begins operation and allows the user access to the system via a standard GUI. This process, however, does not allow the user to view the data in the same context as the user would view the data during operation of the software application using the standard GUI. Also, any modifications to the type of required user-supplied data in the software application require modifications to not only the software application, but also to the installation wizard.

### SUMMARY OF THE INVENTION

In light of the foregoing background, embodiments of the present invention provide improved systems, methods and computer program products for performing a task in a software application. Embodiments of the present invention allow users to perform tasks, such as performing an application configuration, using the same displays that users view while thereafter executing the application during normal operation. Advantageously, by allowing a user to perform tasks such as configuring the application using the same displays presented during normal operation, the content of the displays of the software application can be organized independent of the user-supplied data required to configure and thereafter operate the application. As such, the user-supplied data can be included on several different displays of the software application, where the content of the displays can be organized in a context utilized for operating the software application. The user-supplied data can therefore be located on a respective display with other related data, giving context to the required user-supplied data and making for a better understanding of the meaning of the required data. Further, by allowing users to perform tasks using the same displays that users view while thereafter executing the application during normal operation, embodiments of the present invention do not require instructions or a separate task-performing application, such as an installation wizard, that operates independent of the software application, as required by conventional techniques.

According to one aspect of the present invention, a method is provided for performing a task in a software application, such as a software appliance, capable of presenting at least one operational display during operation. For example, the method can perform the task of configuring the software application for operation. According to one embodiment, the method a state of at least one data item is determined, such as by determining a state of at least one configuration setting. Before determining the state of at least one data item, however, at least one data item (e.g., configuration setting) can be located. After determining the states of the data items, at least one data item is identified based upon the state of the data items. For example, data items having a non-configured state can be identified. Thereafter, at least one operational display of the software application is presented based upon the identified data items. For example, the operational displays presented can comprise electronic pages formatted for display by a connectivity application. Each operational display presented includes at least one field for receiving at least one identified data item. After presenting the operational displays of the software application, the identified data items are received into the fields of the respective operational displays.

More particularly, in embodiments where the state of the data items comprises a state of the configuration settings, configuration settings are identified, operational displays including fields for receiving the configuration settings are presented, and the configuration settings are received for those configuration settings in a non-configured state. As such, the method can further include operating the software application after determining the state of the configuration settings when no configuration settings are identified. When at least one configuration setting is identified, however, software application is operated after receiving the identified configuration settings for those settings having a non-configured state.

The method of one embodiment also includes initializing the software application. Thereafter, the software application is operated to prevent user-controlled access to the operational displays before the state of the data items is determined. Then, after receiving the identified data items, the software application can be operated to permit user-controlled access to the operational displays of the software application. In this regard, after receiving the identified data items, the software application can be operated, including presenting the operational displays having the fields for receiving the identified data items. During operation, then, the operational displays can include the received identified data items.

According to other aspects of the present invention, systems and computer program products are provided for performing a task in a software application. Therefore, embodiments of the present invention provide improved systems, methods and computer program products for performing a task in a software application. Embodiments of the present invention allow users to perform tasks using the same displays that users view while executing the system during normal operation. Advantageously, then, the user-supplied data can be located on a respective display with other related data, giving context to the required user-supplied data and making for a better understanding of the meaning of the required data. Also, by allowing users to perform tasks using the same displays that users view while executing the application during normal operation, embodiments of the present invention also do not require instructions, or a separate task-performing application, such as an installation wizard, that operates independent of the software application, as are typically required in conventional systems. As such, the systems, methods and computer program products of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for performing a task in a software application of one embodiment of the present invention embodied in a computer;

FIG. 2 is a flow chart illustrating various steps in a method of performing a task in a software application according to one embodiment of the present invention;

FIG. 3 is a flow chart illustrating various steps in a method of performing a task in a software application according to another embodiment of the present invention; and

FIGS. 4A-4C are various displays presented by a system for performing a task in a software application in accordance with embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Systems, methods and computer program products according to embodiments of the present invention are capable of performing tasks in a software application. In this regard, the software application can comprise any of a number of different software applications capable of operating on a processing element, such as a personal computer, a network appliance, a server computer or the like. The software application is also typically capable of presenting one, or more typically, a plurality of displays to a user, such as during installation, initialization and/or operation of the software application. The displays are presented via a graphical user interface (GUI) and include content organized such that information required for the system to perform a task, such as application configuration, may be spread across a plurality of displays. In this regard, the displays, and more particularly the information presented on the displays, are typically organized for operational use of the software application, as opposed to performing predetermined tasks, such as configuration of the application. As such, embodiments of the present invention are capable of guiding a user through the displays such that the user is capable of providing information required for the software application to perform a predetermined task.

As used herein, embodiments of the present invention will be shown and described as guiding a user to provide information required during configuration of a software application. It should be understood, however, that the task performed by embodiments of the present invention can comprise any of a number of different tasks capable of being performed in accordance with the present invention, and need not include configuring a software application for operation.

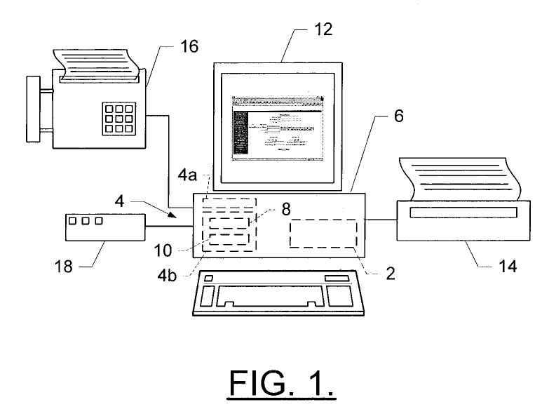

As shown in FIG. 1, the system of one embodiment of the present invention is typically embodied by a processing element 2 and an associated memory device 4, both of which are commonly comprised by a computer 6 or the like. The memory device can comprise any of a number of known memory devices, such as random access memory (RAM) 4a and/or a non-volatile storage device 4b. The non-volatile storage device, such as, for example, flash memory, an EEPROM or a disk, is typically used for storing and/or executing a software application 8 and a task module 10, as well as storing useful data such as, for example, configuration settings required for operation of the software application, as described below. Further, the RAM is generally used for loading and executing the software application and task module, and for storing various pieces of data during execution of the software application.

The computer 6 can include a display unit 12 for presenting information, such as operational displays of the software application 8, in accordance with embodiments of the present invention. To plot information, such as the information presented by the display unit, the computer can further include a printer 14. Also, the computer 10 can include a means for locally or remotely transferring information, such as the information presented by the display unit and/or plotted by the printer. For example, the computer can include a facsimile machine 16 for transmitting information to other facsimile machines, computers or the like. Additionally, or alternatively, the computer can include a modem 18 to transfer information to other computers or the like. Further, the computer can include an interface (not shown) to a network, such as a local area network (LAN) and/or a wide area network (WAN). For example, the computer can include an Ethernet Personal Computer Memory Card International Association (PCMCIA) card configured to transmit and receive information to and from a LAN, WAN or the like.

As will be appreciated, and as described below, neither the software application 8 nor the task module 10 need be stored by the non-volatile storage device 4b. In this regard, the software application and/or the task module can be stored on another processing element, such as another personal computer or server computer, in either wireless or wireline electrical communication with the computer 6, such has via a common network. In such instances, the computer may be capable of remotely accessing and operating the software application and/or the task module from the other processing element. In one embodiment, for example, the computer comprises an appliance. As known to those skilled in the art, appliance computing is a network, or Internet-based, architecture where software applications reside on networked servers typically dedicated to respective applications, rather than on users' personal computers (computer 6). Each of the users' computers, then, typically includes another software application, such as a Web browser, that allows the respective computer to connect to the server to access various software applications.

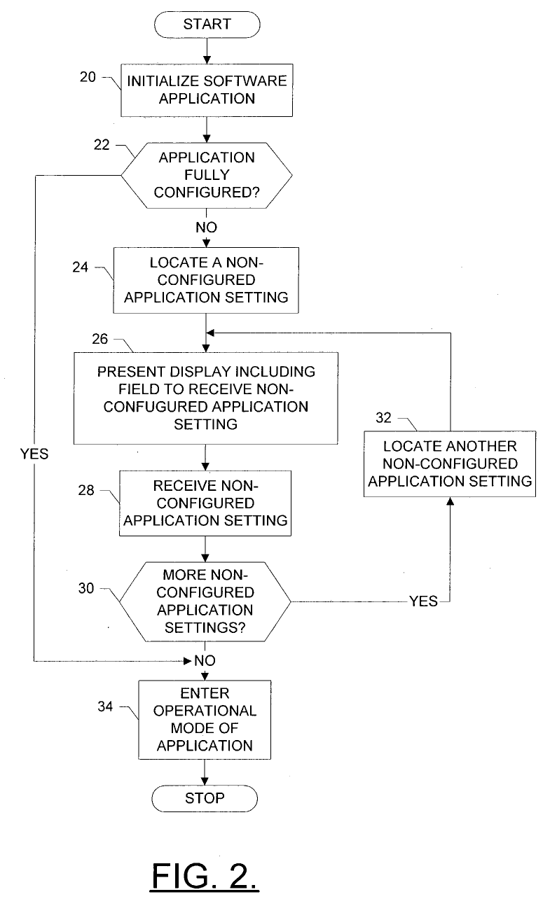

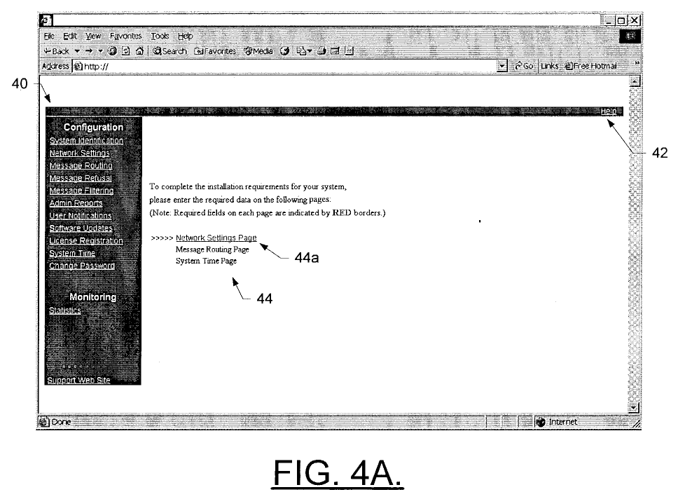

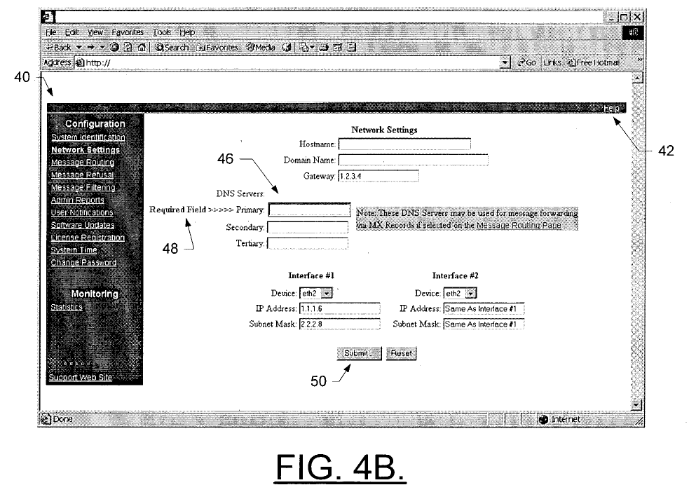

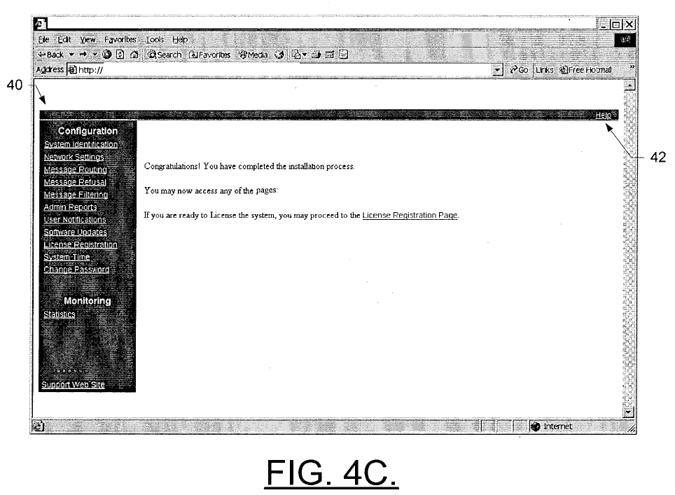

Referring to FIG. 2, a method of performing a task in a software application 8 according to one exemplar embodiment will now be described, where the task comprises configuring the software application for operation. As shown in block 20, the method typically begins by initializing the software application. The software application can be initialized in any of a number of different manners known to those skilled in the art, such as by starting operation of the software application on the personal computer 6. After the software application has been initialized, the task module 10 can search the application to determine whether the application has been fully configured, such as by locating one or more configuration settings and determining a state for each of the located configuration settings, as shown in block 22. For example, the task module can determine a state for each of the located configuration settings by determining whether each configuration setting has been configured or remains non-configured. In this regard, in one embodiment, the application is fully configured when the application has all the configuration settings required to operate. The email secure content management application described below, for example, requires a primary domain name server (DNS), a DNS for incoming email messages, and a time zone (see FIG. 4A). As will be appreciated, the application can be fully configured in any of a number of other manners such as, for example, when the application has all the configuration settings required to operate as well as other data not required to operate, but used during operation of the application.

If the application 8 is fully configured, the task module 10 can permit the application to enter an operational mode and begin to operate utilizing the configuration settings, as shown in block 34. When the application enters the operational mode, then, the application is capable of presenting the displays of the application, and user-controlled access is permitted to such displays. If the application is not fully configured, however, in one embodiment the task module prevents the user from operating the application, such as by preventing user-controlled access to the operational displays of the software application. Alternatively, in another embodiment, the task module may permit the user to at least partially operate the software application without setting the non-configured application settings, or may permit the user to at least partially operate the software application with default configuration settings that may be pre-configured or selected from a list or menu presented to the user. In such instances, the user may be notified of the non-configured application settings, and may also receive a warning as to the lack of such settings.

In instances in which the application is not fully configured, the task module can enter into a configuration mode whereby the task module can identify, and the application can thereafter receive, the configuration settings for those configuration settings in a non-configured state (i.e., non-configured application settings). In other terms, the task module can guide the user through the various operational displays of the application so that the user can enter the required configuration settings into the application. The non-configured application settings can include those settings required for a fully configured application that have not been previously received by the application. More particularly, if the application is not fully configured, the task module can identify a non-configured application setting, as shown in block 24.

Upon identifying a non-configured application setting, the task module 10 can direct the application 8 to present an operational display of the application including a field for receiving the identified application setting, as shown in block 26. The field can comprise any of a number of known field types—for receiving data, including a drop-down menu, a text field, checkbox and/or radio button groups. As will be appreciated, in various instances, including those in which the field comprises a drop-down menu or radio button groups, the configuration setting may be selected from a group of possible configuration settings presented by the respective display. Additionally, to draw the user's attention to the field for receiving the non-configured application setting, the task module can highlight the field. As will be appreciated, the field can be highlighted in any of a number of different manners including, for example, placing a textual, graphical or other notation proximate the field indicating that the field requires a configuration setting.

Advantageously, with the possible exception of highlighting the field for receiving the non-configured application setting, the operational display of the application is presented in the same manner as the same display is presented during subsequent operation of the application 8. In this regard, by allowing a user to input the non-configured application setting into the operational display, the content of the displays of the application can be organized independent of user-supplied data required to configure and thereafter operate the system. As described above, the user-supplied data can therefore be included on several different displays of the software application, where the content of the displays can be organized in a context utilized for operating the software application.

Upon presenting the operational display including the field for receiving the non-configured application setting, the application 8 can receive the non-configured application setting into the field, as shown in block 28. The non-configured application setting can be received in any of a number of different known manners, such as being input by the user in accordance with the type of field for receiving the non-configured application setting. After receiving the non-configured application setting, the task module 10 can search the application for other non-configured application settings, as shown in block 30.

If the application 8 includes other non-configured application settings, the task module 10 can locate the other non-configured application settings, as shown in block 32. The method then repeats for each non-configured application setting, with the task module directing the application to present an operational display of the application including a field for receiving the respective application setting, and the application receiving the non-configured application setting into the field. Advantageously, all of the fields for receiving the other application settings need not be, and typically are not, located on the same operational display. In this regard, as previously indicated, the content of the operational displays can be organized for operation of the application. As such, different operational displays may include different required application settings.

When the application 8 is fully configured, or otherwise does not have any other non-configured application settings, the task module 10 can permit the application to enter an operational mode and begin to operate utilizing the configuration settings, as shown in block 34. During operation, then, the software application can operate and present the operational displays to the user in accordance with operation of the application. In presenting the operational displays, then, the application settings received by the application will typically be presented in the fields of the displays in which the respective settings were received. As indicated above, the task module can prevent the user from operating the application if the application is not fully configured. In this regard, the task module can prevent the user from accessing the displays of the software application if the application is not fully configured. Once the application is fully configured, however, the user may be permitted to view and/or edit the displays presented during operation of the application, including the data in such displays (e.g., the configuration settings), in accordance with operation of the application.

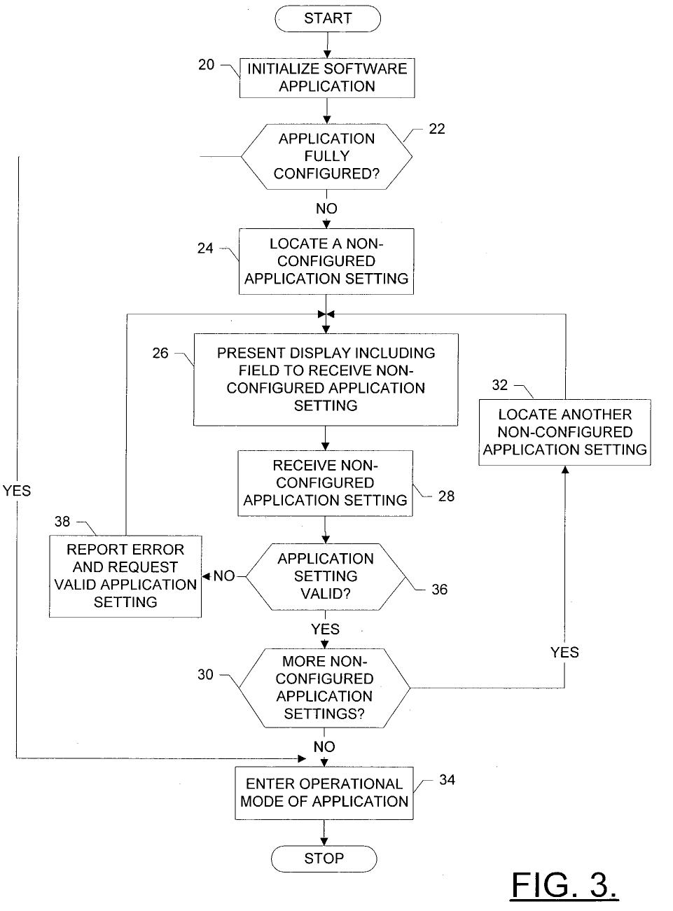

As will be appreciated by those skilled in the art, operation of a software application with user-supplied configuration settings often requires the application to receive valid settings and/or valid combinations of settings. As will also be appreciated, many software applications include provisions to validate user-supplied configuration settings, or combinations of such settings (which combinations may or may not be defined in advance), when the configuration settings are changed. In this regard, to ensure that valid configuration settings have been received by the application 8, and/or that the application has valid combinations of configuration settings, the application can validate the configuration settings, and or combinations of configuration settings, in a manner similar to when the application validates changes to such settings. Additionally, or alternatively, according to another embodiment of the present invention, shown in FIG. 3, the task module 10 can validate the configuration settings and/or combinations of configuration settings. As described below FIG. 3 illustrates a method of performing a task including validating the configuration settings. Although the illustrated method described below does not include validating combinations of configuration settings, it should be appreciated that the method can include validating configuration settings and/or combinations of configuration settings, without departing from the spirit and scope of the present invention.

As shown in FIG. 3, then, the method proceeds as before, with the software application 8 being initialized (block 20), the application being searched to determine whether the application is fully configured (block 22), locating the configuration settings and identifying a non-configured application setting (block 24), and presenting the operational display of the application including a field for receiving the located configuration setting (block 26). In addition, after presenting the field for receiving the located application setting, the application can receive the configuration application setting into the field (block 28). After receiving the non-configured application setting, however, the task module 10 can determine, or direct the application to determine, whether the received configuration setting is valid, as shown in block 36. The configuration setting can be validated in any of a number of known manners, such as by checking the format of the setting to see whether the format of the setting is in compliance with acceptable formats for the respective setting.

If the configuration setting is determined to be invalid, the task module 10 can report, or direct the application 8 to report, that an invalid setting has been received, as shown in block 38. Then, the user can again be presented with the display including the field for receiving the respective setting such that the user can reenter a valid setting. Additionally, the user may be presented with one or more suggestions as to what constitutes a valid setting. Each configuration setting is checked for validity each time the respective configuration setting is received. Then, once the application setting has been validated, the method can continue, as before, by searching the application for other non-configured application settings (block 30), locating the other non-configured application settings (block 32), and thereafter displaying, receiving and validating the other non-configured application settings. Also, as before, when the application is fully configured or otherwise does not have any other non-configured application settings, the task module can permit the application to enter an operational mode and begin to operate, utilizing the received configuration settings, as shown in block 34.

As will be appreciated, in some instances one or more configuration settings may be received into fields on multiple operational displays. In such instances, upon receiving a configuration setting in one field, either initially during configuration or at any subsequent time by changing the configuration setting, the task module 10 may automatically input the respective configuration setting in all other fields of all other operational displays that receive the respective configuration setting. When the configuration setting is received, then, the configuration setting may be validated for all fields into which the respective configuration setting is received. If the configuration setting is invalid for any of the fields, the task module can redisplay the field into which the configuration setting was received to allow the user to input another configuration setting that is valid for all fields into which the respective configuration setting is received or automatically input. Alternatively, the task module may present the displays including the fields where the respective configuration setting is invalid to permit the user to input a valid configuration setting in such fields.

As will also be appreciated, in some instances various of the configuration settings are not required to operate the software application 8. In such instances, the user may be presented with the displays including fields for receiving such optional configuration settings, but the user may choose to not input the optional configuration settings into such fields. The user may then be permitted to at least partially operate the software application after inputting only those configuration settings required to operate the software application. At any time subsequent to skipping the fields for receiving the optional configuration settings, then, the user may return to the respective displays and input the optional configuration settings.

Further, in some instances a user may input a number of configuration settings, but fail to complete configuration of the software application 8 by failing to input a number of configuration settings. In such instances, when the user attempts to operate the software application, such as by initializing the application, the task module 10 may again enter the configuration mode. However, while in the configuration mode, the task module may treat the previously input configuration settings as being configured, and identify only those configuration settings that have a non-configured state. In other terms, the task module can begin the configuration mode where the user may have previously left off by only requesting those configuration settings not received during a previous configuration session.

Further, it should be noted that various software applications 8 may require configuration each time the software application is operated. For those software applications, the task module 10 may enter into the configuration mode each time the software application is initialized. As such, each time the software application is initialized, the task module can guide the user through the various operational displays of the software application to receive the configuration settings.

Reference will now be made to FIGS. 4A-4C, which illustrate various displays that may be presented by a software application operating in accordance with embodiments of the present invention. The software application in the illustrated embodiment comprises an email secure content management appliance that is capable of inspecting email messages and preventing the delivery of messages containing viruses or other undesirable content. Although the following will illustrate and describe one application of the present invention in the context of an email secure content management appliance, it should be understood that the description is for illustrative purposes, and as such, should not in any way be taken to limit the scope of the present invention.

The email secure content management appliance is typically remotely located from the computer 10, and as such, the email secure content management appliance can be accessed from the computer (workstation) via a connectivity software application, such as a conventional Web browser such as Microsoft Internet Explorer or Netscape Navigator. In this regard, the appliance can present a number of different displays that comprise electronic pages formatted for display by the connectivity application, hereinafter referred to as web pages. The web pages can be formatted in any of a number of different formats such as, for example, in the hypertext markup language (HTML), the extensible markup language (XML) or the like. The web pages may also comprise parts written in a script language such as, for example, JavaScript. In this regard, the pages may comprise Java Applets or similar software programs.

According to embodiments of the present invention, the email secure content management appliance can be configured using the exact same web pages that are presented by the appliance during normal operation. As shown in FIGS. 4A-4C, the web pages (i.e., displays) of the email secure content management appliance are organized into different categories of data, with the categories presented in a list 40 on the left side of the web page, and implemented as hyperlinks that bring the user to the web pages handling the respective categories. To functionally operate, the email secure content management appliance requires a number of data items (configuration settings), which are spread across several different web pages. Advantageously, then, each of these required data items is located on a web page with other related data, giving context to the required data items and facilitating a better understanding of the respective required data items. Additionally, on each of these standard web pages, a “Help” 42 link can be provided that, when selected, can direct the appliance to display a detailed description of the respective web page and any required data items located on the respective page.

In operation, a method of performing a task (e.g., configuring the email secure content management appliance) begins by initializing the appliance. The appliance can be initialized in any of a number of different manners. In one embodiment, for example, the appliance is initialized by first entering the Internet protocol (IP) address or Network Hostname of the appliance as the uniform resource locator (URL) in the Web browser. Addressing the appliance, in turn, causes a hypertext transfer protocol (HTTP) request to be sent to the appliance. The network server operating the appliance (i.e., network appliance) receives the request to initialize the appliance, and thereafter generates an HTTP response to be displayed by the Web browser. To generate the proper response, a servlet engine (included within the task module) checks a state variable maintained by the servlet engine. The state variable is typically maintained for the life of the appliance, and can be referred to as the “fully-configured” flag. If the fully-configured flag is set, the appliance has, at some prior time, been configured for operation and, as such, the appliance can be permitted to enter an operational mode, thus allowing random access to the web pages of the appliance. If the fully-configured flag is clear, however, the task module enters a configuration mode by presenting a top-level configuration control web page to the user, as shown in FIG. 4A.

As indicated above, in some instances various of the configuration settings are not required to operate the software application 8. In such instances, the user may be presented with the displays including fields for receiving such optional configuration settings, but the user may choose to not input the optional configuration settings into such fields. The user may then be permitted to at least partially operate the software application after inputting only those configuration settings required to operate the software application. In such embodiments, the servlet engine can check another state variable, referred to as a “mandatory-fields-configured” flag. Then, if the mandatory-fields-configured flag is set, indicating that the mandatory, or required configuration settings have been received by the appliance, the appliance can be permitted to enter an operational mode and at least partially operate. Like before, if the fully-configured flag is set, which typically also requires the mandatory-fields-configured flag to also be set, the appliance can be permitted to enter an operational mode.

The contents of the configuration control web page can be determined in any of a number of different manners. In one embodiment, for example, the servlet includes, or can otherwise locate, obtain, develop or compile, a list of required configuration settings. In operation, then, the current values of each of these settings can be located, such as by another process running on the server. In this regard, the process of obtaining the settings can be performed by a daemon called the element manager, which can be accessed via a socket connection from the servlet. As known to those skilled in the art, a daemon is generally a software application that runs continuously and handles periodic service requests that a server expects to receive. Upon receipt of the current values of the configuration settings, the returned values can be searched to determine whether the settings have been configured. As the returned values are searched, the task module identifies the non-configured application settings, and thereafter formulates the configuration control page to include a list 44 of the non-configured application settings and/or the web pages (i.e., displays) that include fields for receiving the respective settings. As shown in FIG. 4A, then, the “Network Settings Page,” “Message Routing Page,” and “System Time Page” all include at least one field for receiving a non-configured system setting. As will be appreciated, in various embodiments, one or more configuration settings can be included within fields on one or more web pages. In such instances, the configuration control page can be formulated to include any one or more of the web pages including the respective configuration setting.

To guide the user to input the configuration settings in the fields of the respective web pages, the task module can activate the first listed web page (see list 44) on the configuration control web page as a hyperlink to the respective page, with “Network Settings Page” being presented as a hyperlink 44a in FIG. 4A. Upon selecting the active hyperlink, then, the task module can direct the Web browser to present the web page identified by the hyperlink. For example, by selecting the hyperlink for the “Network Settings Page,” the user is presented with the Network Settings web page, as shown in FIG. 4B. As shown, the Network Settings web page includes fields for a number of different data items, including a “hostname,” “domain name,” and “gateway.” In addition, the Network Settings web page includes a field 46 for receiving a “primary DNS server,” identified as a required non-configured application setting. As illustrated, the Network Settings web page includes fields for a number of data items that have not been received by the email secure content management appliance. As such, to distinguish fields for receiving non-configured application settings from other fields that may or may not include other received data items, the display can identify the fields for receiving non-configured application settings, such as via the notation “Required Field >>>>>” 48. In addition, although not shown, the notation can include highlighting, such as by being presented in a color distinct from the other contents of the web page. In addition, the field for receiving the non-configured application setting can also be highlighted, such as by including a color border around the field.

Upon entering a valid primary DNS server value in the respective field, the user can direct the task module to store the valid primary DNS server value, such as by selecting the “Submit” button 50 to thereby submit the Network Settings web page including the valid primary DNS server value. By submitting the page, an HTTP request is executed, thereby directing storage of the primary DNS server value. The primary DNS server value, as well as the web pages and other configuration settings can be stored in a number of different manners, such as by the network server operating the appliance, the computer or workstation attempting to access the appliance, and/or any other computer, server or the like networked with the network server operating the appliance and/or the workstation.

In addition, in embodiments where a configuration setting, such as the primary DNS server value, are located in fields of multiple web pages, the servlet can additionally automatically store the primary DNS server value in the fields of such other web pages. In addition to directing storage of the primary DNS server value, submitting the web page also directs the servlet to check the list 44 (see FIG. 4A) of the non-configured application settings and/or the web pages (i.e., displays). By checking the list 44, the servlet can and identify the next non-configured application setting. The servlet can then update the configuration control web page to activate the next listed web page (e.g., “Message Routing Page”) as a hyperlink. The process would then continue, as before, with the next listed web page being displayed, and the next non-configured application setting being input into the field for receiving the respective non-configured application setting.

After the appliance has received all of the configuration settings, the fully-configured flag can be set. The task module can then present a display indicating that the user has completed configuration of the system, as shown in FIG. 4C. Also, the task module can permit the email secure content management appliance to operate, and allow the user to access any of the web pages (i.e., displays) of the appliance, as such are included in a list 40 as hyperlinks on the left side of the web pages. As the appliance need only be configured once for operation, after the appliance has been configured the user can be permitted to access the web pages in whatever order they choose, entering or modifying any of the system settings as desired.

As described above, the systems, methods and computer program products of embodiments of the present invention are capable of configuring a software application for operation. As indicated above, however, the systems, methods and computer program products of embodiments of the present invention are capable of performing any of a number of different tasks in any of a number of different software applications. For example, embodiments of the present invention can be utilized to provide control flow for the software application to view and/or enter data on various operational displays of the application. Then, based upon the desired data to be viewed and/or entered, embodiments of the present invention can guide a user through a sequence of displays and data items to complete the desired task.

According to one aspect of the present invention, the system (computer 6) of the present invention generally operates under control of a computer program product, referred to in various embodiments as the task module 10. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 2 and 3 are flowcharts of methods, systems and program products according to the invention. It will be understood that each block or step of the flowchart, and combinations of blocks in the flowchart, can be implemented by computer program instructions. These computer program instructions may be loaded onto a computer (e.g., computer 10 on FIG. 1) or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of performing a task in a software application capable of presenting at least one operational display during operation, the method comprising:
determining a state of at least one data item;
identifying at least one data item based upon the state of the at least one data item;
presenting at least one operational display of the software application based upon the identified at least one data item, wherein each operational display presented includes at least one field for receiving at least one identified data item; and
receiving the at least one identified data item into the at least one field of the respective at least one operational display.

2. A method according to claim 1, wherein the task comprises configuring the software application for operation, wherein determining a state of at least one data item comprises determining a state of at least one configuration setting, and wherein identifying at least one data item comprises identifying at least one configuration setting having a non-configured state.

3. A method according to claim 1, wherein the software application is capable of presenting at least one operational display comprising at least one electronic page formatted for display by a connectivity application, wherein presenting at least one operational display comprises presenting at least one electronic page based upon the identified data item, and wherein each electronic page presented includes at least one field for receiving at least one identified data item.

4. A method according to claim 1 further comprising:
initializing the software application; and
operating the software application to prevent user-controlled access to the at least one operational display of the software application, wherein initializing the software application and preventing user-controlled access occur before determining a state of at least one data item.

5. A method according to claim 4 further comprising operating the software application to permit user-controlled access to the at least one operational display of the software application after receiving the at least one identified data item.

6. A method according to claim 1 further comprising operating the software application after receiving the at least one identified data item, wherein operating the software application includes presenting the at least one operational display including at least one field for receiving at least one identified data item, and wherein presenting the at least one operational display includes presenting the at least one operational display including the received at least one identified data item.

7. A method according to claim 6, wherein the software application operates from a network appliance, and wherein operating the software application comprises operating the software application from a remotely located workstation.

8. A method according to claim 1, wherein determining a state comprises determining a state of at least one configuration setting, wherein identifying at least one data item comprises identifying at least one configuration setting when the at least one configuration setting is in a non-configured state, wherein presenting at least one operational display comprises presenting at least one operational display when at least one configuration setting is identified, and wherein receiving the at least one identified data item comprises receiving the at least one data item when at least one data item is identified.

9. A method according to claim 8 further comprising operating the software application after at least one of determining a state when no configuration settings are identified, and after receiving the at least one identified data item when at least one configuration setting is identified.

10. A method according to claim 1 further comprising locating at least one data item before determining a state of the at least one data item.

11. A method according to claim 10, wherein the task comprises configuring the software application for operation, wherein locating at least one data item comprises locating at least one configuration setting, wherein determining a state of at least one data item comprises determining a state of the at least one configuration setting, and wherein identifying at least one data item comprises identifying at least one configuration setting having a non-configured state.

12. A system for performing a task in a software application capable of presenting at least one operational display during operation, the system comprising:
a processing element capable of determining a state of at least one data item, wherein the processing element is also capable of identifying at least one data item based upon the state of the at least one data item; and
a display unit capable of presenting at least one operational display of the software application based upon the identified at least one data item, wherein each operational display presented includes at least one field for receiving at least one identified data item,
wherein the processing element is capable of receiving the at least one identified data item into the at least one field of the respective at least one operational display.

13. A system according to claim 12, wherein the task comprises configuring the software application for operation, wherein the state of the at least one data item comprises a state of at least one configuration setting, and wherein the processing element is capable of identifying at least one configuration setting having a non-configured state.

14. A system according to claim 12, wherein the at least one operational display comprises at least one electronic page formatted for display by a connectivity application, wherein the display unit is capable of presenting at least one electronic page based upon the identified data item, and wherein each electronic page presented includes at least one field for receiving at least one identified data item.

15. A system according to claim 12, wherein the processing element is also capable of initializing the software application, and thereafter operating the software application to prevent user-controlled access to the at least one operational display of the software application before determining a state of at least one data item.

16. A system according to claim 15, wherein the processing element is further capable of operating the software application to permit user-controlled access to the at least one operational display of the software application after receiving the at least one identified data item.

17. A system according to claim 12, wherein the processing element is further capable of operating the software application after receiving the at least one identified data item, wherein the display unit is capable of presenting the at least one operational display including at least one field for receiving at least one identified data item during operation of the software application, and wherein the at least one operational display presented during operation of the software application includes the received at least one identified data item.

18. A system according to claim 17, wherein the software application comprises a software appliance.

19. A system according to claim 12, wherein the state of the at least one data item comprises a state of at least one configuration setting, wherein the processing element is capable of identifying at least one configuration setting when the at least one configuration setting is in a non-configured state, wherein the display unit is capable of presenting at least one operational display when at least one configuration setting is identified, and wherein the processing element is capable of receiving the at least one data item when at least one data item is identified.

20. A system according to claim 19, wherein the processing element is further capable of operating the software application after at least one of determining a state when no configuration settings are identified, and after receiving the at least one identified data item when at least one configuration setting is identified.

21. A system according to claim 12, wherein the processing element comprises a workstation having a web browser, wherein the display is capable of presenting at least one operational display via the web browser, and wherein the system further comprises:
a network in electrical communication with the workstation, the network including a network appliance capable of communicating with the workstation via the web browser.

22. A system according to claim 21, wherein each operational display comprises a web page, wherein each web page includes a listing of the categories of data, and wherein each category in the listing is embodied in a hyperlink.

23. A system according to claim 22, wherein the workstation is capable of identifying at least one data item comprising at least one configuration setting, and wherein at least two fields for receiving at least two configuration settings are located on different web pages.

24. A system according to claim 23, wherein each configuration setting is located on a web page along with data in the same category as the respective configuration setting.

25. A system according to claim 24, wherein the category of each web page provides a context for a configuration setting located on the respective web page, and facilitates an understanding of a meaning of the respective configuration setting.

26. A system according to claim 22, wherein each web page includes at least one hyperlink to at least one other web page.

27. A system according to claim 21, wherein the system further includes a network server capable of being accessed by the workstation and the network appliance.

28. A system according to claim 27, wherein each operational display comprises a web page, and wherein the at least one web page is stored by the network server.

29. A system according to claim 27, wherein the workstation is capable of identifying at least one data item comprising at least one configuration setting, wherein the configuration settings are stored by at least one of the network appliance and the network server, and wherein the wherein the configuration settings are accessed by identifying the network appliance.

30. A computer program product for performing a task in a software application capable of presenting at least one operational display during operation, the computer program product comprising a computer-readable storage medium having computer-readable program code portions stored therein, the computer-readable program portions comprising:
a first executable portion for determining a state of at least one data item;
a second executable portion for identifying at least one data item based upon the state of the at least one data item;
a third executable portion for presenting at least one operational display of the software application based upon the identified at least one data item, wherein each operational display presented includes at least one field for receiving at least one identified data item; and
a fourth executable portion for receiving the at least one identified data item into the at least one field of the respective at least one operational display.

31. A computer program product according to claim 30, wherein the task comprises configuring the software application for operation, wherein the first executable portion determines a state of at least one configuration setting, and wherein the second executable portion selects at least one configuration setting having a non-configured state.

32. A computer program product according to claim 30, wherein the software application is capable of presenting at least one operational display comprising at least one electronic page formatted for display by a connectivity application, wherein the third executable portion presents at least one electronic page based upon the identified data item, and wherein each electronic page presented includes at least one field for receiving at least one identified data item.

33. A computer program product according to claim 30 further comprising:
a fifth executable portion initializing the software application; and
a sixth executable portion operating the software application to prevent user-controlled access to the at least one operational display of the software application, wherein the fifth and sixth executable portions initialize the software application and prevent user-controlled access, respectively, before the first executable portion determines a state of at least one data item.

34. A computer program product according to claim 33 further comprising a seventh executable portion for operating the software application to permit user-controlled access to the at least one operational display of the software application after the fourth executable portion receives the at least one identified data item.

35. A computer program product according to claim 30 further comprising a fifth executable portion for operating the software application after the fourth executable portion receives the at least one identified data item, wherein the fifth executable portion presenting the at least one operational display including at least one field for receiving at least one identified data item during operation of the software application, and wherein the at least one operational display presented by the fifth executable portion includes the received at least one identified data item.

36. A computer program product according to claim 35, wherein the fifth executable portion operates the software application comprising a software appliance.

37. A computer program product according to claim 30, wherein the first executable portion determines a state of at least one configuration setting, wherein the second executable portion selects at least one configuration setting when the at least one configuration setting is in a non-configured state, wherein the third executable portion presents at least one operational display when at least one configuration setting is identified, and wherein the fourth executable portion receives the at least one data item when at least one data item is identified.

38. A computer program product according to claim 37 further comprising a fifth executable portion for operating the software application after at least one of the first executable portion determines a state when no configuration settings are identified, and after the fourth executable portion receives the at least one identified data item when at least one configuration setting is identified.

39. A method of installing and operating an information system computer program product in a system including a workstation having a web browser, wherein the system also includes a remote network having a network appliance capable of being in communication with the workstation via the web browser, the method comprising:
organizing a number of configuration settings of the network appliance into a set of web pages, wherein each web page includes a different category of data;
inspecting a state of the network appliance based upon the configuration settings; and
presenting at least one of the web pages via the web browser based upon the state of the network appliance.

40. A method according to claim 39 further comprising entering a configuration mode when the network appliance has a non-configured state.

41. A method according to claim 40, wherein entering a configuration mode comprises presenting a configuration control web page that identifies at least one configuration setting.

42. A method according to claim 39 further comprising operating the network appliance when the network appliance has a configured state, wherein operating the network appliance comprises permitting random access to the web pages.

43. A method according to claim 39 further comprising locating at least one configuration setting based upon the state of the network appliance, wherein the at least one configuration setting is located before presenting the set of web pages.

44. A method according to claim 39 further comprising changing at least one configuration setting after presenting at least one web page, wherein changing the at least one configuration setting occurs independent of a separate installation wizard and at least one installation display.

45. A method according to claim 39 further comprising operating the network appliance when the network appliance has a configured state, wherein operating the network appliance comprises operating the network appliance with the set of web pages including the configuration settings.

46. A system according to claim 39, wherein at least one web page includes at least one field for receiving at least one configuration setting, and wherein presenting at least one of the web pages comprises presenting at least one of the web pages highlighting the at least one field for receiving the at least one configuration setting.
